(19) United States
(12) Patent Application Publication
(10) Pub. No.: US 2007/0226208 A1
(43) Pub. Date: Sep. 27, 2007

(54) INFORMATION RETRIEVAL DEVICE

(75) Inventors: Daisuke Morita, Kawasaki (JP); Shigeru Hidesawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/422,372

(22) Filed: Jun. 6, 2006

(30) Foreign Application Priority Data
Mar. 23, 2006 (JP) 2006-081659

(51) Int. Cl. G06F 17/30

(52) U.S. Cl. 707/5

(57) ABSTRACT

In order for even a user not used to retrieval to be able to easily and rapidly obtain desired information, the information retrieval device 10 comprises a first retrieval unit 11 for performing retrieval, using a first retrieval character string, a retrieval result display unit 12 for outputting display data displaying identifiably second retrieval character string candidates together with its retrieval result, a second retrieval character string selection unit 13 capable of selecting a second retrieval character string and a second retrieval unit 14 for adding the second retrieval character string to the first retrieval character string and implementing the first retrieval unit 11.

### BACKGROUND OF THE INVENTION

1. Field of the Invention

The present invention relates to an information retrieval device for search for desired information using a keyword.

2. Description of the Invention

Keyword retrieval is widely used as a means for searching for desired data among a large amount of data which is distributed and exists on the Internet or data in a database.

When performing keyword retrieval, a user prepares several keywords which seem to be related to the desired information and retrieval is performed. However, its retrieval result often varies greatly depending on the selection of the used keywords. Sometimes there is too much information hit by the keywords and all of them cannot be seen. Sometimes there is not a piece of information hit by the keywords at all.

If there is too much information hit by the keywords, more keywords must be added and the retrieval results must be attempted to narrow them. However, the retrieval result varies greatly depending on a keyword used in this case and sometimes desired information won't be able to be obtained. For example, by adding only one keyword, sometimes there is not a piece of hit information at all.

As described above, if a user is not used to keyword retrieval, the user cannot easily obtain desired information.

Japanese Patent Application Publication No. H05-143647 discloses a database retrieval processing method for facilitating narrowing work by keyword retrieval, by displaying the existence frequency of each keyword owned by a target to be obtained by the retrieval on a screen.

Japanese Patent Application Publication No. H05-165892 discloses an information retrieval device capable of easily and efficiently narrowing a primary retrieval result by displaying the appearance information of each different character string included in each piece of data of the primary retrieval result and determining a subsequent appropriate retrieval character string based on this appearance information.

### SUMMARY OF THE INVENTION

It is an object of the present invention to provide an information retrieval device by which even a user not used to retrieval can easily and rapidly obtain desired information in order to solve the above-described problem.

In order to solve the above-described problem, the information retrieval device of the present invention comprises a first retrieval unit searching for information including a character string which coincides with a first retrieval character string composed of one or more inputted character strings, a retrieval result display unit extracting second retrieval character string candidates used to further narrow the result of the retrieval from character strings included in the information obtained by the retrieval of the first retrieval unit and outputting display data displaying identifiably a second retrieval character string candidates together with the retrieval result, a second retrieval character string selection unit capable of selecting a desired second retrieval character string from the second retrieval character string candidates displayed identifiably and a second retrieval unit adding the retrieval character string selected by the second retrieval character string selection unit to the first retrieval character string and performing the retrieval by the first retrieval unit.

According to the present invention, the retrieval result display unit extracts the second retrieval character string candidates from the result of the retrieval by the first retrieval unit and outputs the display data displaying identifiably the second retrieval character string candidates to the display unit together with the result of the retrieval by the first retrieval unit. Therefore, even a user not used to retrieval can easily select the second retrieval character string for further narrowing the retrieval result.

Since the second retrieval unit adds the retrieval character string selected by the user using the second retrieval character string selection unit to the first retrieval character string and performs the retrieval by the first retrieval unit, the user can further narrow the retrieval result only by selecting an arbitrary retrieval character string from the second retrieval character string candidates by the second retrieval character string selection unit.

As described above, according to the present invention, an information retrieval device by which even a user not used to retrieval can easily and rapidly obtain desired information can be provided.

### BRIEF DESCRIPTION OF THE DRAWINGS

FIG. 1 shows the outline of the information retrieval device in the preferred embodiment of the present invention;

FIG. 2 shows an example of the configuration needed to implement the information retrieval device in the preferred embodiment of the present invention;

FIG. 3 is a flowchart showing the outline of the process of the information retrieval device in the preferred embodiment of the present invention;

FIG. 4 shows the display data in the preferred embodiment of the present invention;

FIG. 5 is a flowchart showing the generation process of the display data by the information retrieval device in the preferred embodiment of the present invention;

FIG. 6 shows an example of a text file stored in the retrieval database in the preferred embodiment of the present invention;

FIG. 7 shows an example of the file list information in the preferred embodiment of the present invention;

FIG. 8 shows an example of the temporary analysis file in the preferred embodiment of the present invention;

FIG. 9 shows the image of an analysis result obtained when a morphological analysis is applied to the temporary analysis file; and

FIG. 10 shows an example of the appearance frequency list information in the preferred embodiment of the present invention.

### DESCRIPTION OF THE PREFERRED EMBODIMENTS

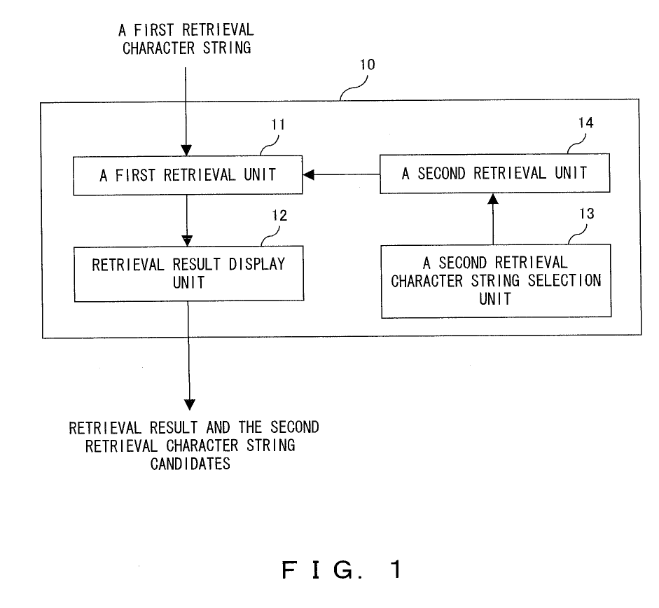

The preferred embodiments of the present invention are described below with reference to FIGS. 1 through 10.

FIG. 1 shows the outline of the information retrieval device 10 in the preferred embodiment of the present invention.

The information retrieval device 10 shown in FIG. 1 comprises a first retrieval unit 11 for searching for information using a first retrieval character string, a retrieval result display unit 12 for outputting display data displaying identifiably the second retrieval character string candidates together with the result of the retrieval by the first retrieval unit 11 to a display unit, which is not shown in FIG. 1, a second retrieval character string selection unit 13 capable of selecting a desired second retrieval character string from the second retrieval character string candidates displayed on the display unit and a second retrieval unit 14 for adding the second retrieval character string to the first retrieval character string, and performing the retrieval by the first retrieval unit 11.

The first retrieval unit 11 searches for information including a character string which coincides with the first retrieval character string composed of one or more character strings (including alphabet/numerals, symbols and the like) inputted by a user. Then, the first retrieval unit 11 outputs the result of the retrieval.

The information retrieval device 10 can search for the information including a character string which coincides with the first retrieval character string among an information group (or database) stored in a storage device directly or indirectly via a network or the like, connected to the information retrieval device 10. Alternatively, the information retrieval device 10 can search for the information including a character string which coincides with the first retrieval character string among an information group (or database) stored in an information processing device connected via a network, such as the Internet or the like.

The retrieval result is, for example, the list information of hit information including at least the name of information including a character string which coincides with the first retrieval character string (hereinafter simply called “hit information”) and the storage place of the hit information.

The retrieval result display unit 12 extracts second retrieval character string candidates used to further narrow the retrieval result from the character strings included in the information hit by the first retrieval unit 11.

For example, the second retrieval character string candidates can be selected in descending order of the appearance frequency of character strings included in the hit information. Alternatively, the second retrieval character string candidates can be selected in descending order of the relation or similarity to the first character string out of the character strings included in the hit information.

Furthermore, the retrieval result display unit 12 generates display data displaying identifiably the second retrieval character strings as a list and outputs the data together with the retrieval result.

The display data, for example, displays a part of or the full name (item name) of each piece of hit information and the information itself, and displays identifiably the second retrieval character strings included in a part or all of the information. Alternatively, the display data displays the name of each piece of hit information and the second retrieval character string candidates included in the information as a list.

As the display data, for example, data in a hypertext markup language (HTML) form, extensible markup language (XML) form, extensible hypertext markup language form or the like, is used, as requested.

The second retrieval character selection unit 13 enables to select the second retrieval character string from the second retrieval character string candidates displayed on the display unit. For example, when the user specifies the second retrieval character string candidate displayed on the display unit by an input unit, such as a mouse or the like, the second retrieval character selection unit 13 obtains the specified retrieval character string as the second retrieval character string.

The second retrieval unit 14 adds the second retrieval character string obtained by the second retrieval character selection unit 13 to the first retrieval character string and implements the first retrieval unit 11.

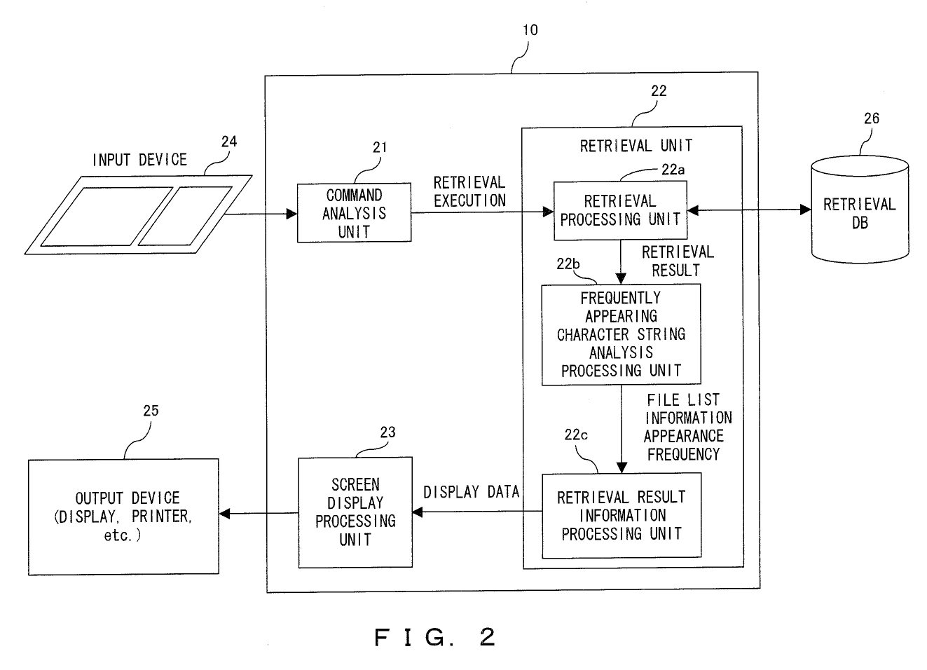

FIG. 2 shows an example of the configuration needed to implement the information retrieval device 10 in the preferred embodiment of the present invention.

The information retrieval device 10 shown in FIG. 2 comprises at least a command analysis unit 21 for generating a retrieval execute command according to an instruction from an input device 24 and instructing to execute retrieval, a retrieval unit 22 for performing retrieval according to the instruction of the command analysis unit 21 and a screen display processing unit 23 for outputting the display data generated by the retrieval unit 22 to an output device 25.

The retrieval unit 22 comprises a retrieval processing unit 22a for executing the command generated by the command analysis unit 21 (activating a retrieval engine by the command), a frequently-appearing character string analysis processing unit 22b for generating file list information 70 and appearance frequency list information 100, which are described later, from the retrieval result and a retrieval result information processing unit 22c for generating a retrieval result and display data displaying identifiably the second retrieval character string candidates from the file list information 70 and the appearance frequency list information 100.

To the information retrieval device 10, an input device 24 for inputting the first retrieval character string, selecting the second retrieval character string, and instructing to perform its retrieval and the like, an output device 25 for displaying or printing the display data and a retrieval database 26 to be retrieved are connected.

When the first retrieval character string is inputted by the input device 24 (for example, a mouse or a keyboard) and its retrieval execution is instructed, the command analysis unit 21 generates a retrieval execute command and instructs the retrieval execution.

The retrieval unit 22 executes a command according to the instruction of the command analysis unit 21 to perform retrieval. Then, the retrieval unit 22 generates a retrieval result and display data displaying the second retrieval character string identifiably.

The screen display processing unit 23 outputs them to the output device 25 (for example, a display) to display the display data.

When the user selects the second retrieval character string, using the input device 24, according to the display on the monitor, the command analysis unit 21 adds the second retrieval character string to the first retrieval character string, and also generates a retrieval execute command and instructs retrieval execution.

Although in the above-described configuration, the retrieval database 26 is connected to the information retrieval device 10, the connection is not limited to this. For example, if a retrieval target is data on the Internet, the information retrieval device 10 can be connected to the Internet.

The information retrieval device 10 comprising the above-described components (command analysis unit 21, retrieval unit 22 and screen display processing unit 23) can be realized by a general information processing device. Specifically, the command analysis unit 21, the retrieval unit 22 and the screen display processing unit 23 can be realized by enabling a CPU to execute a program stored in memory provided for an information processing device.

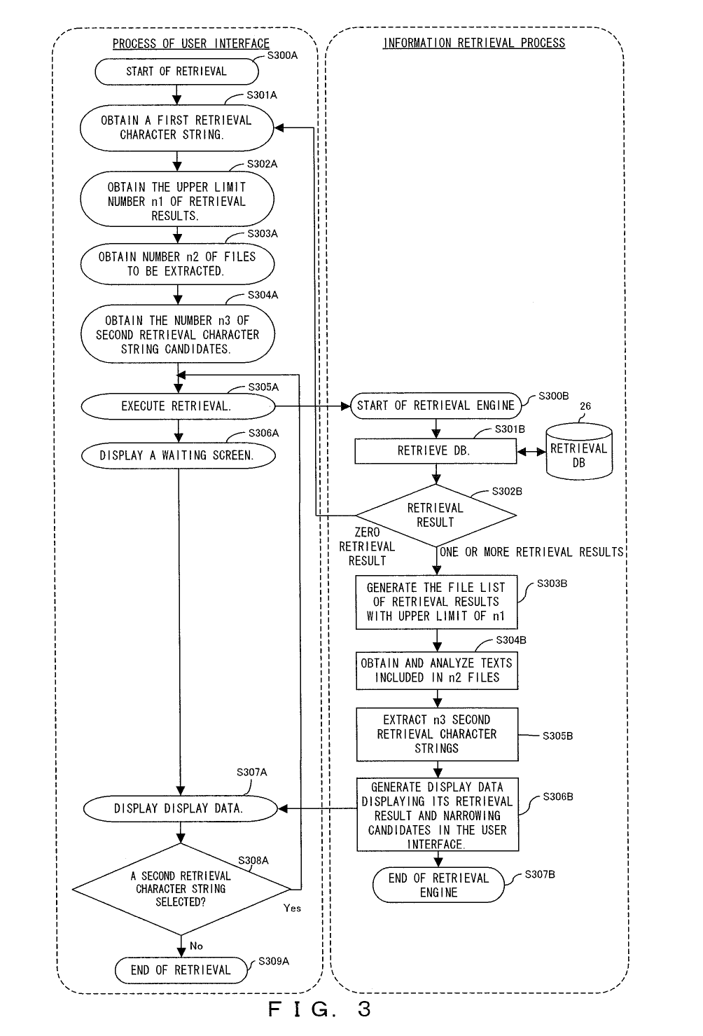

FIG. 3 is a flowchart showing the outline of the process of the information retrieval device 10 in the preferred embodiment of the present invention. The steps S300A through S309A, steps S300B through S307B shown in FIG. 3 respectively indicate a user interface process and an information retrieval process operated by receiving an instruction from a user interface.

When a user starts the information retrieval device 10, the information retrieval device 10 displays the input field of the first retrieval character string and the input fields of variables n1 through n3 described later on a display (step S300A).

In step S301A, the information retrieval device 10 obtains a character string inputted to the input field by the user as the first retrieval character string. Similarly, in steps S302A through S304, the information retrieval device 10 obtains the respective values inputted to the input fields by the user as the upper limit number n1 of retrieval results, the number n2 of files to be extracted and the number n3 of the second retrieval character string candidates.

The upper limit number n1 of retrieval results indicates the upper limit number of information items displayed as retrieval results of a plurality of pieces of information hit by retrieval and the number n2 of files to be extracted indicates the number of files used to extract the second retrieval character string candidates. The number n3 of the second retrieval character strings candidates indicates the number of the second retrieval character strings candidates displayed identifiably together with the retrieval result.

After the input of the first retrieval character string and the variables n1 though n3 is completed, the user instructs retrieval execution by pushing down a “retrieve” button by a mouse or the like.

In step S305A, the information retrieval device 10 detects a “retrieve” button pressed, activates a retrieval engine and starts a retrieval process.

In step S306A, the information retrieval device 10 displays a waiting screen on a display. For example, “during retrieval”, a cancel button for cancellation execution or the like is displayed.

In step S307A, the information retrieval device 10 displays the display data generated by the retrieval process on the display. Then, the process of the information retrieval device proceeds to step S308A.

In step S308A, the information retrieval device 10 checks whether the second retrieval character string is selected from the second retrieval character string candidates displayed in step S307A. Then, if the second retrieval character string is selected, the second retrieval character string is added to the first retrieval character string obtained in step S310A. the process of the information retrieval device proceeds to step S305A to perform retrieval.

If in step S308A, no second retrieval character string is selected, the process of the information retrieval device proceeds to step S309A to terminate the retrieval process (or wait for an input).

If in step S305A, the pushdown of the “retrieve” button is detected, the process of the information retrieval device proceeds to step S300B and the information retrieval device 10 starts the retrieval engine. Then, the process of the information retrieval device proceeds to step S301B.

In step S301B, the information retrieval device 10 performs keyword retrieval using the first retrieval character string obtained in step S301A. By the keyword retrieval, a file including a character string which coincides with the first retrieval character string is extracted from the retrieval database 26. Although the retrieval target of the information retrieval device 10 of this preferred embodiment is the retrieval database 26, the retrieval target can also be the entire Internet.

In step S302B, the information retrieval device 10 checks the result of the keyword retrieval. If the number of information items hit by the first retrieval character string is zero, the process of the information retrieval device proceeds to step S301A.

If in step S302B, the number of information items hit by the first retrieval character string is one or more, the information retrieval device 10 proceeds to step S303B.

In step S303B, the information retrieval device 10 obtains n1 arbitrary files from files hit by the retrieval in step S301B and generates the file list information 70. When n1 arbitrary files are obtained from the files hit by the retrieval in step S301B, for example, the file list information 70 can be generated by obtaining n1 files in order where the n1 file are detected (hit) by the retrieval engine.

In step S304B, the information retrieval device 10 selects n2 arbitrary files from the file list information 70 generated in step S303B. Then, the information retrieval device 10 obtains text data included in each selected file and extracts, for example, only nouns after analyzing the text data into parts of speech, using, for example, a morphological analysis method.

In step S305B, the information retrieval device 10 counts the appearance frequency of the nouns (character strings) extracted in step S304B and generate the appearance frequency list information 100. Then, the information retrieval device 10 extracts n3 character strings in descending order of the appearance frequency. These extracted character strings are specified as the second retrieval character string candidates.

In step S306B, the information retrieval device 10 refers to the file list information 70 generated in step S303B and generates a file name and display data displaying a part of the contents of the file. In this case, if there is a character string which coincides with the second retrieval character string candidate extracted in step S305B, in the file contents, it generates display data capable of displaying identifiably that the character string is the second retrieval character string, for example, by color, an affix or the like, on descending order of the appearance frequency.

When the display data is generated, the information retrieval device 10 proceeds to step S307B to terminate the retrieval engine.

In the above-description, n1, n2 and n3 set by the user in steps S302A through S304A can also be stored in a storage unit provided for the information retrieval device 10 in advance.

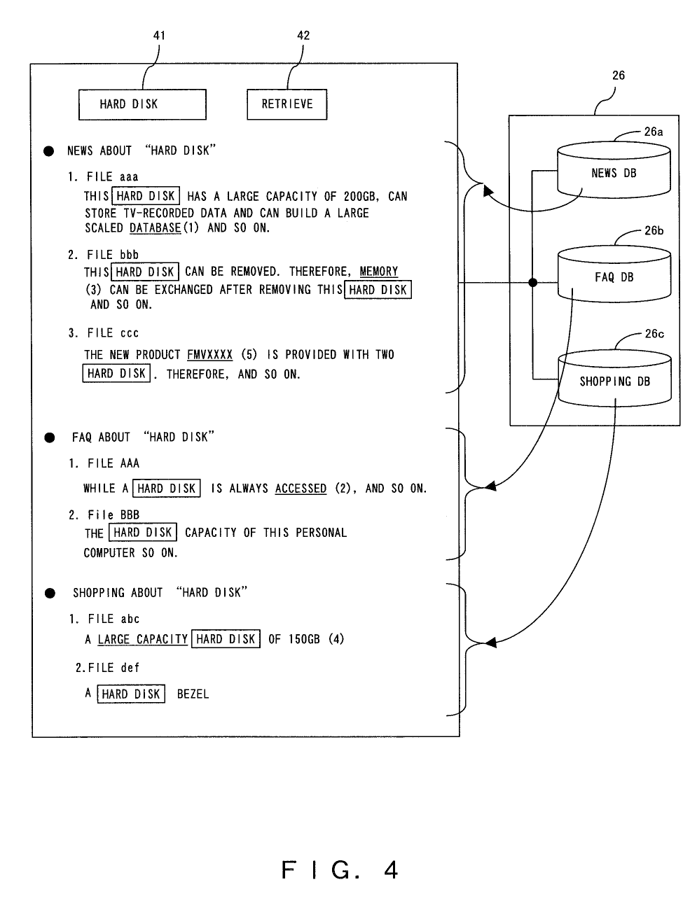

FIG. 4 shows the display data in the preferred embodiment of the present invention.

The display by the display data shown in FIG. 4 comprises the input field 41 of the first retrieval character string, a “retrieve” button 42 for starting retrieval and the list information composed of the file names of the file list information 70 generated in step S 303B (for example, “file aaa”, “file bbb”, “file ccc”, and so on shown in FIG. 4) and a part of the contents of each file (for example, “this hard disk has a large capacity of 200 GB, can store TV-recorded data and can build a large-scaled database and so on”).

An enclosed character string “hard disk” indicates that the character string is the first retrieval character string, an underlined character string indicates the second retrieval character string candidates (for example, a database, access, memory and the like).

Numbers (1), (2) and the like are attached to the second retrieval character strings in descending order of its appearance frequency. Specifically, it is shown that the respective appearance frequency of “database”, “access”, “memory ”, “large capacity” and the like are large in that order.

In this case, the retrieval target of the information retrieval device 10 in this preferred embodiment is the retrieval database 26. This retrieval database 26 comprises a NEWS database 26a for storing news information, an FAQ database 26b for storing data in one-question-to-one answer form and a shopping database 26c for storing shopping information.

Therefore, the display data of this preferred embodiment displays the file names of the file list information 70 and a part of the contents of each file which are generated for each retrieval target in step S 303B as a list. For example, NEWS about “hard disk” and FAQ about “hard disk” respectively indicate the result obtained by retrieving the NEWS database 26a and the result obtained by retrieving data from the FAQ database 26b. Shopping about “hard disk” indicates a result obtained by retrieving data from the shopping database 26c.

The specific example of the generation process of the display data by the information retrieval device 10 in the preferred embodiment of the present invention is described below.

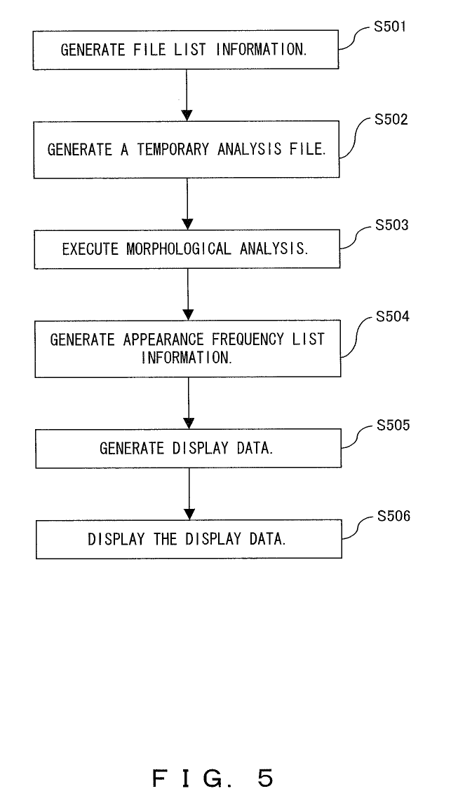

FIG. 5 is a flowchart showing the generation process (in particular the detailed processes in steps S303B through S306B shown in FIG. 3) of the display data by the information retrieval device 10 in the preferred embodiment of the present invention.

In step S501, the information retrieval device 10 obtains n1 arbitrary files from files hit by the retrieval process in step S301B shown in FIG. 3 and generates file list information 70.

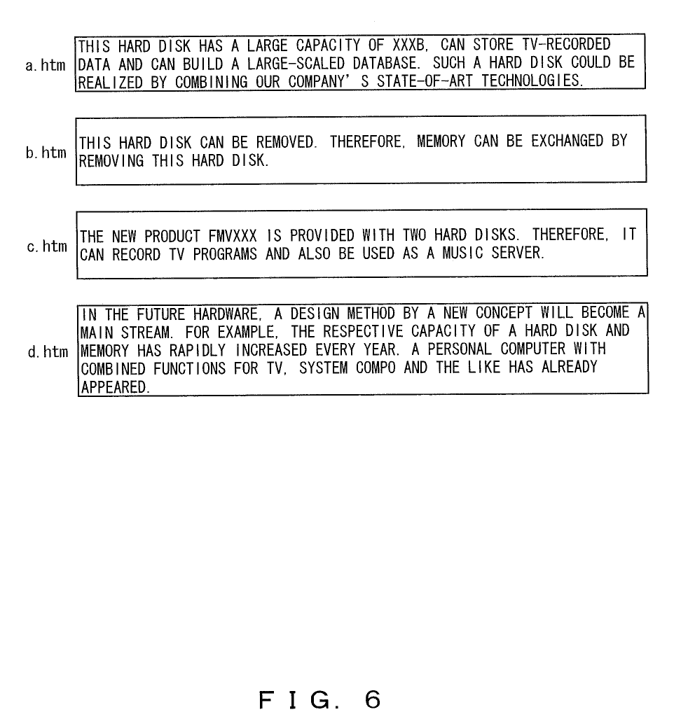

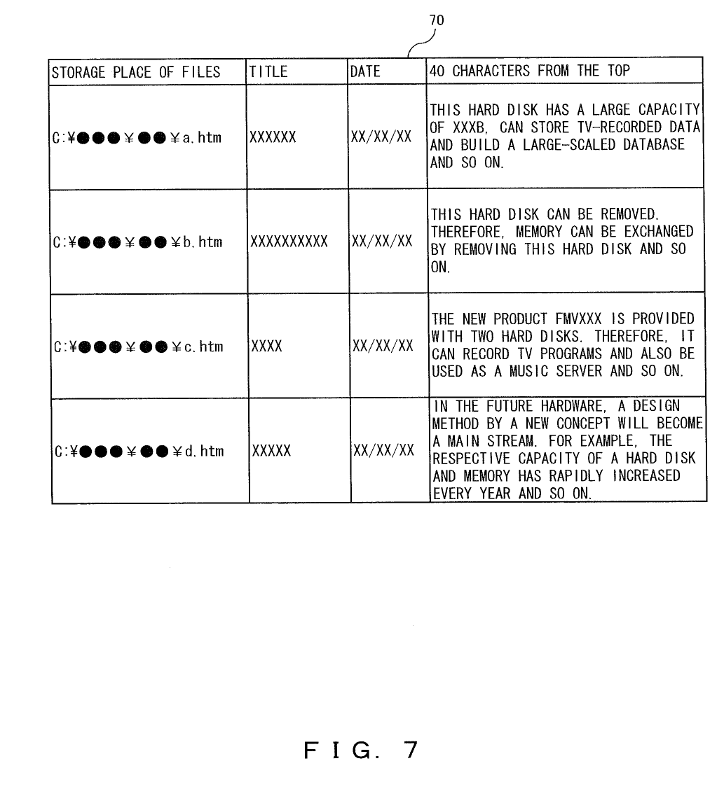

For example, if keyword retrieval is performed using the first retrieval character string “hard disk” when the text files a.htm, b.htm, c.htm and d. htm shown in FIG. 6 are stored in the retrieval database 26, the information retrieval device 10 generates the file list information 70 shown in FIG. 7.

In this case, the file list information 70 shown in FIG. 7 comprises the storage place of files hit by the first retrieval character string, the title (name) of the file, the update date/time of the file and the information of 40 characters from the top stored in the file.

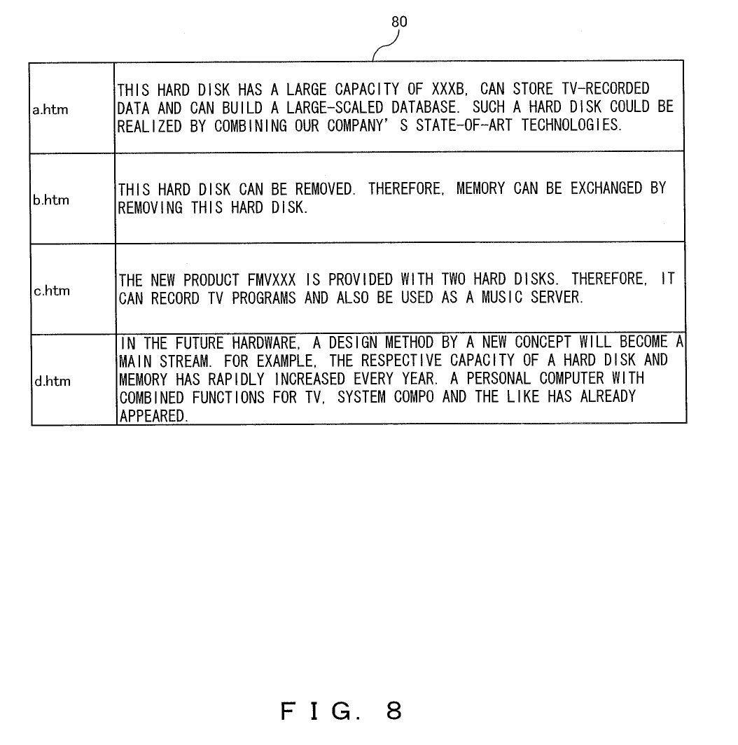

In step S502, the information retrieval device 10 refers to the file list information generated in step S501 and reads the text data of each file. Then, the information retrieval device 10 generates the temporary analysis file 80 shown in FIG. 8.

In this case, the temporary analysis file 80 comprises a file name stored in the file list information 70 and text data stored in the file, as shown in FIG. 8.

After generating the temporary analysis file 80, the process of the information retrieval device 10 proceeds to step S503.

In step S503, the information retrieval device 10 applies a morphological analysis to the text data of each file in the temporary analysis file 80 generated in step S502 to analyze the data into parts of speech.

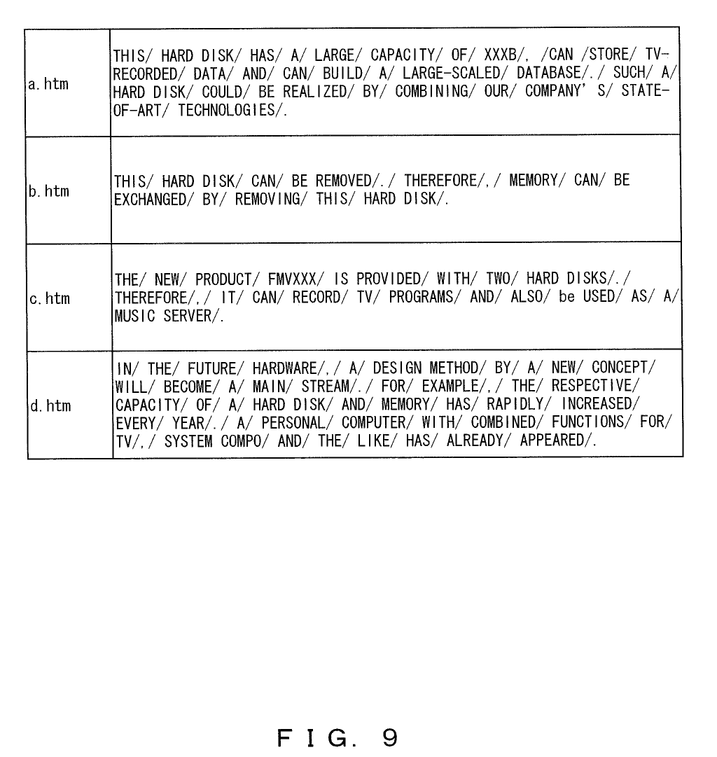

FIG. 9 shows the image of an analysis result obtained when a morphological analysis is applied to the temporary analysis file 80. “/” indicates the partition of speech parts. Since the morphological analysis is a general art, its detailed description is omitted here.

After the morphological analysis of the temporary analysis file 80 is completed, the process of the information retrieval device 10 proceeds to step S504.

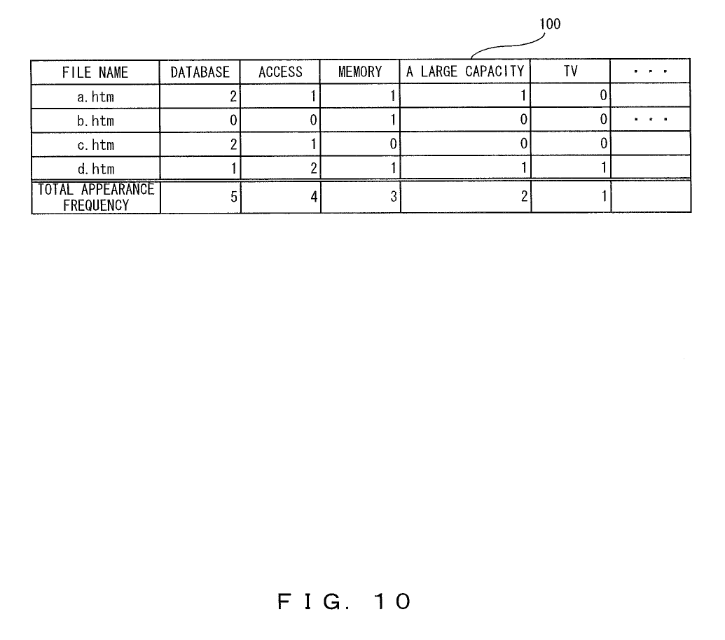

In step S504, the information retrieval device 10 extracts only nouns from the text data of each file analyzed into parts of speech by the morphological analysis in step S 503. Then, the information retrieval device 10 counts the appearance frequency of each extracted noun and generates the appearance frequency list information 100 shown in FIG. 10.

In this case, the appearance frequency list information 100 comprises the name of a file obtained from the temporary analysis file 80, the noun character string obtained by the morphological analysis applied to the text data of each file (“database”, “access”, “memory”, “large capacity”, “TV” and the like) and the total number of times of appearance (total appearance frequency) of each character string.

After generating the appearance frequency list information 100, the information retrieval device 10 selects n3 character strings in descending order of the total appearance frequency. These selected character strings are specified as the second retrieval character string candidates.

When the second retrieval character string candidates are determined, the process of the information retrieval device 10 proceeds to step S505. Then, the information retrieval device 10 generates the display data in the display form shown in FIG. 4 in the form of HTML or the like.

When the display data is generated, the process of the information retrieval device 10 proceeds to step S506. Then, the information retrieval device 10 outputs the display data on the monitor to display it.

As described above, the information retrieval device 10 extracts the second retrieval character string candidates from the keyword retrieving result using a first retrieval character string input by a user to further narrow the first retrieving result. And the information retrieval device 10 displays identifiably the second retrieval character string candidates together with the result of the retrieval by the first retrieval character string.

When the user selects any of the displayed second retrieval character strings, the information retrieval device 10 adds the second retrieval character string to the first retrieval character string and performs keyword retrieval.

As a result, even a user not used to retrieval can easily and rapidly narrow the retrieval result and obtain desired information only by selecting one of the displayed second retrieval character strings displayed on a monitor or the like.

What is claimed is:

1. An information retrieval device, comprising:
a first retrieval unit searching for information including a character string which coincides with at least one first retrieval character string;
a retrieval result display unit extracting second retrieval character string candidates used to further narrow a result of the retrieval from character strings included in the information obtained by the retrieval of the first retrieval unit and outputting display data displaying identifiably a second retrieval character string candidates together with a retrieval result;
a second retrieval character string selection unit capable of selecting a desired second retrieval character string from the second retrieval character string candidates displayed identifiably; and
a second retrieval unit adding the retrieval character string selected by the second retrieval character string selection unit to the first retrieval character string and performing retrieval by the first retrieval unit.

2. The information retrieval device according to claim 1, wherein
the retrieval result display unit comprises
a character string extraction unit extracting a specific character string from the information obtained by the retrieval by the first retrieval unit;
a frequently appearing character string extraction unit extracting frequently appearing character strings from the extracted character strings as the second retrieval character string candidate; and
a retrieval result output unit generating display data displaying identifiably the second retrieval character string candidates extracted by the frequently appearing character string extraction unit together with a result of the retrieval by the first retrieval unit and outputting them to a display unit.

3. The information retrieval device according to claim 1, wherein
the display data displays at least a name of information obtained by the retrieval by the first retrieval unit and a part or all of the information, and displays identifiably the second retrieval character string candidates included in the display.

4. An information retrieval method for enabling an information retrieval device to execute a process, the process comprising:
a first retrieval process of searching for information including a character string which coincides with at least one first retrieval character string and storing its retrieval result in a storage unit;
a retrieval result display process of reading the retrieval result from the storage unit, extracting second retrieval character string candidates used to further narrow the retrieval result from character strings included in the information obtained by the retrieval and outputting display data displaying identifiably a second retrieval character string together with the retrieval result;
a second retrieval character string selection process capable of selecting a desired second retrieval character string from the second retrieval character string candidates displayed identifiably; and
a second retrieval process of adding the retrieval character string selected by the second retrieval character string selection process to the first retrieval character string and performing retrieval by the first retrieval process.

5. The information retrieval method according to claim 4, wherein
the retrieval result display process enables an information retrieval device to execute a process, the process comprising:
a character string extraction process of extracting a specific character string from the information obtained by the retrieval by the first retrieval process;
a frequently appearing character string extraction process of extracting frequently appearing character strings from the extracted character strings and specifying them as the second retrieval character string candidates; and
a retrieval result output process of generating display data displaying identifiably the second retrieval character string candidates extracted by the frequently appearing character string extraction process together with a result of the retrieval by the first retrieval process and outputting them to a display unit.

6. The information retrieval method according to claim 4, wherein
the display data displays at least a name of information obtained by the retrieval by the first retrieval process and a part or all of the information, and displays identifiably the second retrieval character string candidates included in the display.

7. A recording medium storing an information retrieval program for enabling an information retrieval device to execute a process, the process comprising:
a first retrieval process of searching for information including a character string which coincides with at least one first retrieval character string and storing its retrieval result in a storage unit;
a retrieval result display process of reading the retrieval result from the storage unit, extracting second retrieval character string candidates used to further narrow the retrieval result from character strings included in the information obtained by the retrieval and outputting display data displaying identifiably the second retrieval character string candidates together with the retrieval result;
a second retrieval character string selection process of selecting a desired second retrieval character string from the second retrieval character string candidates displayed identifiably; and
a second retrieval process of adding the retrieval character string selected by the second retrieval character string selection process to the first retrieval character string and performing retrieval by the first retrieval process.

8. The recording medium storing the information retrieval program according to claim 7, for enabling an information retrieval device to execute a process, wherein
the retrieval result display process enables an information retrieval device to execute a process, the process comprising:
a character string extraction process of extracting specific character strings from the information obtained by the retrieval by the first retrieval process;
a frequently appearing character string extraction process of extracting frequently appearing character strings from the extracted character strings and specifying them as the second retrieval character string candidates; and
a retrieval result output process of generating display data displaying identifiably the second retrieval character string candidates extracted by the frequently appearing character string extraction process together with a result of the retrieval by the first retrieval process and outputting them to a display unit.

9. The recording medium storing the information retrieval program according to claim 7, for enabling an information retrieval device to execute a process, wherein
the display data displays at least a name of information obtained by the retrieval by the first retrieval process and a part or all of the information, and displays identifiably the second retrieval character string candidates included in the display.
